(19) United States
(12) Patent Application Publication
(10) Pub. No.: US 2010/0047476 A1
(43) Pub. Date: Feb. 25, 2010

(54) Silicon Nanoparticle Precursor

(76) Inventors: Jer-Shen Maa, Vancouver, WA (US); Gregory S. Herman, Vancouver, WA (US); Apostolos T. Voutsas, Portland, OR (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(21) Appl. No.: 12/195,673

(22) Filed: Aug. 21, 2008

(51) Int. Cl. B05D 5/12; H01B 1/04

(52) U.S. Cl. 427/596; 427/77; 252/500; 423/349; 427/595

(57) ABSTRACT

A Si nanoparticle precursor, precursor fabrication process, and precursor deposition process are presented. The method for forming a silicon (Si) nanoparticle precursor provides a plurality of nanoparticle classes, including at least one Si nanoparticle class. The nanoparticles in each nanoparticle class are defined as having a predetermined diameter. A predetermined amount of each nanoparticle class is measured and combined. For example, a first Si nanoparticle class may be provided having a largest diameter and a second Si nanoparticle class having a second-largest diameter equal to about (0.43)×(the largest diameter). As another example, Si nanoparticle classes may foe provided having a diameter ratio of about 77:32:17.

### BACKGROUND OF THE INVENTION

1. Field of the Invention

This invention generally relates to integrated circuit (IC) fabrication and, more particularly, to a silicon (Si) nanoparticle precursor that can be sintered at low temperatures to form Si thin-films.

2. Description of the Related Art

Silicon, thin-film transistors (TFTs) are commonly used as active-matrix devices in flat-panel displays. Due to severe competition within the display industry, cost reduction in the fabrication process is always an essential goal in the design of new products. Conventionally, a TFT fabrication process uses several chemical vapor deposition (CVD) and/or sputtering steps to deposit semiconductor, insulator, and conductor materials, which require vacuum systems, gas delivery, and control units. These methods result in blanket coated films, which require patterning, typically by multiple photolithography and etch steps. The cost of these processes could be reduced significantly if these steps could be replaced with a simple printing technique.

It has been reported that silicon films can be formed from silane-based liquid precursor (“Solution-processed silicon films and transistors”, Nature 440, 783-786, Apr. 6, 2006). Shimoda et al. reported that TFTs with mobilities of 108 cm²V⁻¹s⁻¹ and 6.5 cm²V⁻¹s⁻¹ were achieved on polycrystalline silicon prepared from spin-coating and ink-jet printing using liquid silicon precursors. Tanaka et al. reported on the formation of n-type silicon films using phosphorous-doped polysilanes (“Spin-on n-type silicon films using phosphorous-doped polysilanes”, Japanese J. Appl. Phys., 46, L886-L888, 2007). Shiho has claimed a polysilane compound with at least one from cyclopentasilane, cyclohexasilane, and silylcyclopentasilane (U.S. Pat. No. 7,067,069). Si particles of 5 nm to μm sizes, with 0.1 to 100 wt %, were dispersed in the silane composition. Si films were then formed with lamp or laser exposure at room temperature to 300° C., in a non-oxidizing atmosphere.

Zurcher has claimed a Si nanoparticle ink (<100 ma sizes) which comprise a molecular precursor, such as a polysilane, silylene, or organo-silane. A Ge-based molecular precursor such as polygermane, germylene, or organo-germane can also be combined with Si-based precursor (U.S. Pat. No. 7,078,276). He has also claimed the use of hydrogen capped nanoparticles of Si or Ge dispersed in a solvent medium to form nanoparticle ink, and Si-based or Ge-based molecular precursors (U.S. Pat. No. 7,259,101).

Bet et al. has reported that Si film can be formed from nanoparticles after laser annealing without using liquid silane (“Laser forming of silicon films using nanoparticle precursor”, S. Bet et al., J. Electron. Mat., 35, 993, 2006, and US 2007/0218657).

Most, of the above-mentioned researchers claims that liquid Si-containing precursors can be applied to substrate as an ink-like material, and through heating or irradiation, are converted into amorphous or polycrystalline silicon films. However, such a practice is limited by considerations of cost and safety. It is known that many of the claimed materials are flammable and in some cases, such as germanium-containing precursor, can also be toxic. In fact, some high molecule silicon hydrides have been suggested for use in a combustion chamber as missile propellant (U.S. Pat. No. 5,775,096).

Although a safe operation can be maintained in an enclosure using sophisticated safety precautions, the manufacturing costs associated with flammable materials are high. The end result may be that the cost of a so-called “low-cost” Si printing process will become too high for actual practice.

Since the safety issue associated with the use of Ge and liquid silane is related to the concentration of these materials, it would be advantageous to minimize the amount of liquid Si or Ge compounds used in a Si precursor. However, none of the above-mentioned methods provide an analysis of the amount or percentage of Si-containing compound required to form silicon films.

It would be advantageous if the safety of Si ink or printable materials could be enhanced by reducing the required amount of the liquid silane used in Si precursors.

### SUMMARY OF THE INVENTION

The Si precursor disclosed herein minimizes, or completely eliminates the amount of a liquid silane compound needed to form a printable Si precursor, which is referred to herein as a Si nanoparticle precursor. In one aspect, the Si nanoparticle precursor is a Si-containing solution, containing Si nanoparticles, liquid silane compounds, and solvents. The major constituent of the solution is Si nanoparticles. Liquid silane compounds serves as an agent to form channels between Si nanoparticles, to form a continuous Si film after heating or light irradiation. The Si nanoparticle precursor minimizes the amount of liquid silane needed to form the proper channels by maximizing the packing of Si nanoparticles.

After deposition, the sintering of Si nanoparticles requires an elevated temperature. The sintering temperature can be reduced significantly if the connection channels are formed from liquid silane or from Ge nanoparticles. The Si nanoparticle precursor uses a designed size ratio of Si nanoparticles, to minimize the amount of liquid silane, or to reduce the use of Ge nanoparticles.

Accordingly, a method is provided for forming a Si nanoparticle precursor. The method provides a plurality of nanoparticle classes, including at least one Si nanoparticle class. The nanoparticles in each nanoparticle class are defined as having a predetermined diameter. A predetermined amount of each nanoparticle class is measured and combined. For example, a first Si nanoparticle class may be provided having a largest diameter and a second Si nanoparticle class having a second-largest diameter equal to about (0.43)×(the largest diameter). As another example. Si nanoparticle classes may be provided having a diameter ratio of about 77:32:17.

In some aspects, the method measures a predetermined amount of liquid silane, which is combined with a plurality of Si nanoparticle classes. In other aspects, at least one class of germanium (Ge) nanoparticles is provided, which is combined with a Si nanoparticle class and liquid silane.

Additional details of the above-described method, as well as a method for forming a Si thin-film from a Si nanoparticle precursor are provided below.

### BRIEF DESCRIPTION OF THE DRAWINGS

FIG. 1 is a schematic diagram of a silicon (Si) nanoparticle precursor.

FIG. 2 is a schematic diagram depicting a first variation of the Si nanoparticle precursor of FIG. 1.

FIG. 3 is a schematic diagram depicting a second variation of the Si nanoparticle precursor of FIG. 1.

FIG. 4 is a schematic diagram depicting closely packed spheres of a single diameter.

FIG. 5 is a schematic diagram depicting the closely packed spheres of FIG. 4 with smaller sized spheres to fill the void.

FIG. 6 is a table depicting an empirically derived relationship between spheres.

FIG. 7 is a flowchart illustrating a method for forming a Si nanoparticle precursor.

FIG. 8 is a flowchart illustrating a method for forming a Si thin-film from a Si nanoparticle precursor.

### DETAILED DESCRIPTION

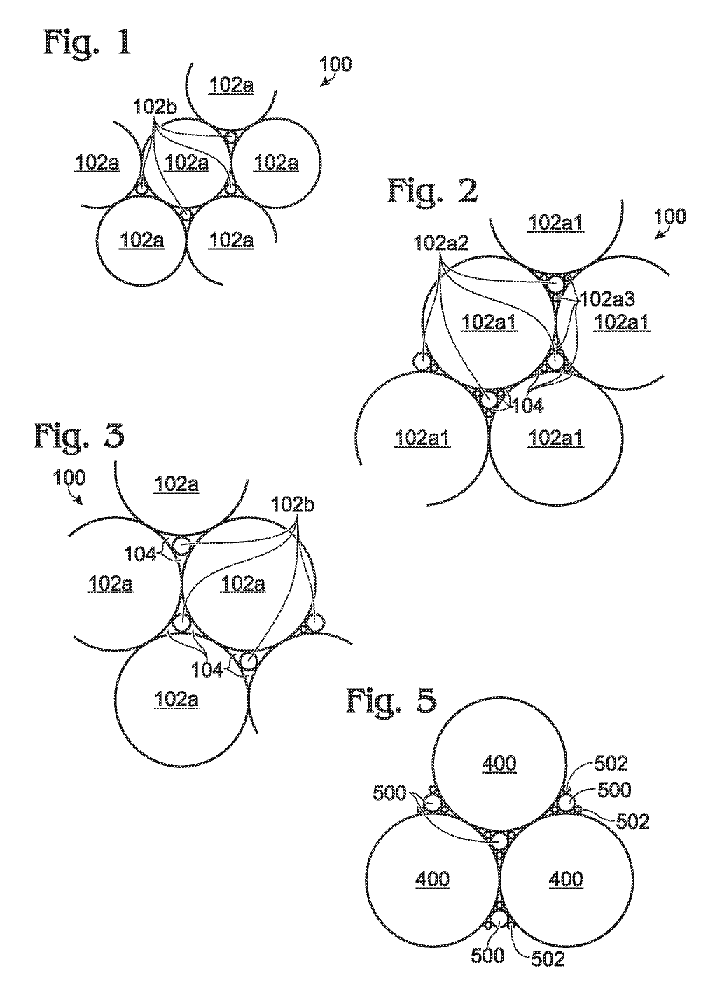

FIG. 1 is a schematic diagram of a silicon (Si) nanoparticle precursor. The Si nanoparticle precursor 100 comprises a combination of nanoparticle classes 102, including at least one Si nanoparticle class 102a. The nanoparticles in each nanoparticle class have a predetermined diameter, and the volume of each nanoparticle class is measured in a predetermined amount. In one aspect, the nanoparticle diameter tolerance is in the range of ±10%. A nanoparticle class may alternately be described as a set or group of nanoparticles made from the same material and having approximately the same diameter. Shown are nanoparticle classes 102a and 102b. Wren two classes of nanoparticles are used, the void between particles, as explained in more detail below, is less than that of only one class of nanoparticles. When three classes of nanoparticles are used, the void between particles is less than one or two classes of nanoparticles. When four classes of nanoparticles are used, the void between particles is less than one, two, or three classes of nanoparticles.

FIG. 2 is a schematic diagram depicting a first variation of the Si nanoparticle precursor of FIG. 1. In this aspect the precursor 100 includes a predetermined amount of liquid silane 104, and the combination of nanoparticle classes 102 includes a plurality of Si nanoparticle classes 102a. Shown are Si nanoparticle classes 102a1, 102a2, and 102a3. However, the precursor 100 is not limited to any particular number of Si nanoparticle classes. The liquid silane ubiquitously fills the void between nanoparticle classes 102a1, 102a2, and 102a3. The amount of liquid silane is predetermined so that the precursor includes enough liquid silane to fill the voids.

FIG. 3 is a schematic diagram depicting a second variation of the Si nanoparticle precursor of FIG. 1. As in FIG. 2, the precursor 100 includes a predetermined amount of liquid silane 104. In this aspect, the combination of nanoparticle classes 102 includes at least one class of germanium (Ge) nanoparticles 102b. Shown are one Si nanoparticle class 102a and one Ge nanoparticle class 102b. However, the precursor 100 is not limited to any particular number of Si nanoparticle classes or Ge nanoparticle classes.

### Functional Description

Even when liquid silane is used, as shown in FIGS. 2 and 3, the Si nanoparticle precursor advantageously uses a minimum amount of liquid silane compounds. The major constituent of Si nanoparticle precursor solution is Si nanoparticles. Liquid silane compounds are added to serve as an agent to form channels between Si nanoparticles, making a continuous Si film after heating or light irradiation. The disclosed Si nanoparticle precursor uses the minimum amount of liquid silane needed to form the proper channels. Preferably, the channels provide a path of electrical conductivity from one nanoparticle to each adjacent nanoparticle.

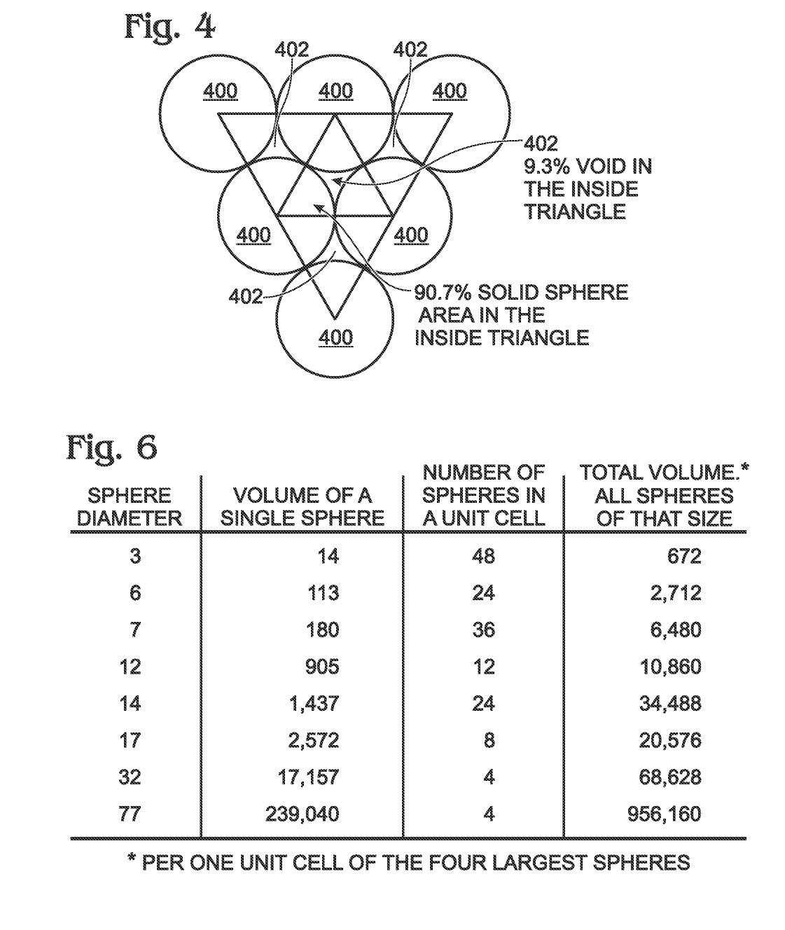

FIG. 4 is a schematic diagram depicting closely packed spheres of a single diameter. In two dimensions, the packing density of the spheres 400 can be easily calculated, and the area ratio of spheres and voids can then be determined. From the area of the inside triangle, it can be determined that the area theoretically occupied by spheres of a single class is 90.7% of the total area, and that the pores 402 (voids) are only 9.3% of the total area.

FIG. 5 is a schematic diagram depicting the closely packed spheres of FIG. 4 with smaller sized spheres to fill the void. The size of the next size sphere to best fill the pores between the three large spheres 400 can also be determined. The radius of the next size sphere 500 is 15.5% of the large spheres. In some aspects as shown, a next smaller size of sphere 502 can added to optimally fill the remaining void.

However, in 3 dimensions, the calculation of the optimal combination of sphere sizes becomes quite complicated. In a three dimensional closest packed assembly of spheres, the volume occupied by the largest spheres is calculated to be 74% of the total volume, while the pores occupy 26% of the total volume. The size of next size sphere that optimally fits into the pores can be estimated by the following relationship;

(2-D size ratio)/(2-D volume ratio)=(3_D size ratio)(3-D volume ratio)

Since the 2-D size ratio is 15.5, the 2-D volume ratio is 9.3, and the 3-D volume ratio is 26, the 3-D size ratio is estimated to be (15.5×26)/9.3-43%. Therefore, the radius of the next size sphere that can optimally fit into the pores between the large spheres is estimated here to be about 43% of the radius of the large spheres.

FIG. 6 is a table depicting an empirically derived relationship between spheres. The above-disclosed estimation is not far from the experimental results reported by D. Shanefield (Organic Additives and Ceramic Processing, 2^{nd}, with Applications in Powder Metallurgy, Ink and Paint, Kluwer Academic Publishers, 1999). Depicted in the table is a relationship between eight sizes of spheres, where about 95% packing is allegedly achieved.

From the table it is observed that the size ratio of the largest and second largest spheres is 32/77, which is about 42%. This result is very close to calculation above. Most of the volume is occupied by a few (4) of the largest spheres, with a much smaller volume for the medium size and small size particles. With the proper distribution of nanoparticle sizes, the pores only occupy a small portion of the total volume.

In M. Rahaman's book, Ceramic Processing and Sintering, 2^{nd} edition. Marcel Dekker, Inc., 2003, the maximum packing density of a binary mixture is stated to be 86.8%. When the interstitial holes in the binary mixture are filled with a large number of very fine spheres in dense random packing, the maximum packing density becomes 95.2%. The maximum packing density of quaternary mixtures is stated to be 98.3%.

By using nanoparticles of mixed sizes, and adding liquid silane to fill in the remaining pores, the amount of liquid silane can be reduced to a minimum, approximately <5-15% of the total volume, depending on the combination of the size and distribution of the nanoparticles.

Liquid silane precursors can be formed from silane based monomers including, but not limited to, cyclotrisilane, cyclobutasilane, cyclopentasilane, cyclohexasilane, and cycloheptasilane. These cyclic monomers have a high propensity towards photo-polymerized resulting in silane precursor materials with an increase in molecular weight and concurrent boiling point. Other silane based monomers include, but not limited to, monosilane, disilane or trisilane. These silane based monomers can be polymerized through homogeneous or heterogeneous catalytic reactions. Linear or branched polymers can be formed depending on the reaction conditions. The silane precursors can be dissolved in a variety of hydrocarbon solvents such as n-hexane, n-heptane, n-octane, n-decane, benzene, toluene, xylene, and ether solvents such as dipropyl ether, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, tetrahydrofuran, and polar solvents such as, H-methyl-2-pyrrolidone, dimethylformamide, acetonitrile and dim ethyl sulfoxide.

An alternative method is to add smaller Ge nanoparticles to the interstitial sites of Si particles. Since the melting point of Ge is much lower than Si, and Ge can absorb near IR radiation, liquid sintering occurs, forming Ge or SiGe channels to connect the Si nanoparticles.

In summary, mixed sizes of Si nanoparticles are used in the Si nanoparticle precursor to increase packing density. In some aspects, liquid silane is added to fill in the remaining voids. The amount of liquid silane can be reduced to only a portion of the total volume, for example 5-15%. Diluting liquid silane in a proper solvent permits the liquid silane to settle into the pores among the nanoparticles. The liquid silane can be replaced or augmented with Ge nanoparticles, or liquid germane. Using nanoparticles of mixed sizes, under proper annealing condition, the use of liquid silane or germanium can be completely eliminated. In this case, the mixed nanoparticle sizes increase the packing density and enhance the direct contacts among the Si nanoparticles.

### EXAMPLE 1

Mix Si particles in a size ratio of around 77:32:17 or 77:32:17:D, where D=12˜14. As an example, the sizes of the particles can be: 39 nm, 16 nm, and 8˜9 nm. The ratio of wt. % is: 956 gm (39 nm):69 gm (16 nm):21 gm (8˜9 nm). Since the nanoparticle material is silicon in this example, the weight ratio is directly proportional to the volume ratio as shown in the table of FIG. 6.

Add a liquid silane compound dissolved in an organic solvent, with volume ratio of 5˜15% of the total volume. When liquid silane is added, Si nanoparticles are arranged in two or more classes. For example, 77:32, 77:32:17, or more combinations.

### EXAMPLE 2

Mix Si nanoparticles with Ge nanoparticles, in a size ratio of 77 (Si):32 (Ge) or 77 (Si):32 (Si):17 (Ge). There are multiple ways to form the mixture. The weight ratio is adjusted according to the density of silicon and germanium, and follows the volume ratio of the table in FIG. 6.

Annealing can be performed in an inert environment using a furnace, laser, rapid thermal annealing (RTA), or by flash lamp annealing method.

Although the addition of liquid silane or Ge can help form conduction channels among Si nanoparticles at a much lower temperature, it is also possible to form Si films by arranging the nanoparticles in proper size ratio without the addition of liquid silane or Ge. Si nanoparticles with size ratio of 77:32:17 or 77:32:1.7:12˜14 can be mixed in a dispersion solution and applied onto substrates. Sintering is then performed using one of the above-mentioned annealing methods.

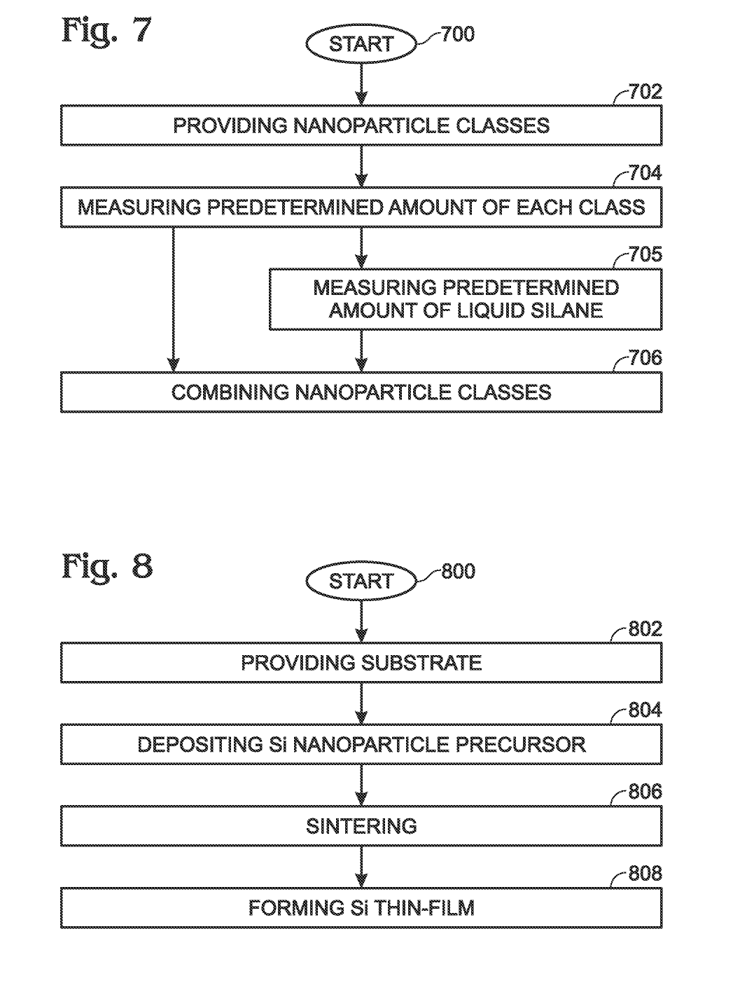

FIG. 7 is a flowchart illustrating a method for forming a Si nanoparticle precursor. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 700.

Step 702 provides a plurality of nanoparticle classes, including at least one Si nanoparticle class. The nanoparticles in each nanoparticle class having a predetermined diameter. In one aspect, the diameter tolerance is ±10%. However, the method is not necessarily limited to any particular range of tolerances. Step 704 measures a predetermined amount of each nanoparticle class. Step 706 combines the nanoparticle classes.

In one aspect. Step 705 measures a predetermined amount, of liquid silane, and Step 706 combines a plurality of Si nanoparticle classes with the liquid silane. For example, Step 705 may measure liquid silane with a volume in the range of about 5 to 15%, as compared to the combined volume of the Si nanoparticle classes. Some examples of liquid silane include cyclotrisilane, cyclobutasilane, cyclopentasilane, cyclohexasilane, and cycloheptasilane. Alternately, Step 705 measures a volume of liquid germane in the range of about 0 to 15%, as compared to the combined volume of the Si nanoparticle classes.

In another aspect, Step 702 provides at least one class of germanium (Ge) nanoparticles, and Step 705 measures a predetermined amount of liquid silane. Then, Step 706 combines a Si nanoparticle class, liquid silane, and the Ge nanoparticle class. More explicitly, providing the Si nanoparticle class and the Ge nanoparticle class in Step 702 may includes providing diameter ratio of about 77(Si):32(Ge), or a fourth ratio of about 77(Si):32(Si):17(Ge).

In one example, providing the Si nanoparticle class in Step 702 includes providing a first Si nanoparticle class having a largest diameter and a second Si nanoparticle class having a second-largest diameter equal to about (0.43)×(the largest diameter).

In another example. Step 702 provides Si nanoparticle classes having a of first diameter ratio of about 77:32:17, or a second diameter ratio of about 77:32; 17:D, where D is in a range of about 12-14. To continue the example, measuring the predetermined amount of each Si nanoparticle class (Step 704) includes measuring the first ratio in a corresponding weight % ratio of about 956:69:21.

FIG. 8 is a flowchart illustrating a method for forming a Si thin-film from a Si nanoparticle precursor. The method starts at Step 800. Step 802 provides a substrate. Step 804 deposits a Si nanoparticle precursor overlying the substrate. The Si nanoparticle precursor includes a predetermined amount from at least one Si nanoparticle class, where each class includes nanoparticles having a predetermined diameter. The plurality of nanoparticle classes may be dissolved in a hydrocarbon, ether, or polar solvent. Step 806 sinters the Si nanoparticle precursor at a first temperature, or less. In one aspect, sintering is performed in an inert environment, using a furnace, laser, rapid thermal, or flash lamp annealing operation. If solvents are used, they are evaporated in the sintering process. Step 808 forms a Si thin-film.

If Step 804 deposits a Si nanoparticle precursor formed exclusively from Si nanoparticle classes. Then, sintering the Si nanoparticle precursor in Step 806 includes sintering at the first temperature.

In one aspect, depositing the Si nanoparticle precursor in Step 804 includes depositing a Si nanoparticle precursor with a plurality of Si nanoparticle classes and a predetermined amount of liquid silane. Some examples of liquid silane include cyclotrisilane, cyclobutasilane, cyclopentasilane, cyclohexasilane, and cycloheptasilane. Then, sintering the Si nanoparticle precursor in Step 806 includes sintering at a second temperature, less than the first temperature. For example, Step 804 may deposit a volume of liquid silane in the range of about 5 to 15%, as compared to the combined volume of the Si nanoparticle classes.

In another aspect. Step 804 deposits a Si nanoparticle precursor including a predetermined amount of at least one germanium (Ge) nanoparticle class and a predetermined amount of liquid silane. Then, sintering the Si nanoparticle precursor in Step 806 includes sintering at a third temperature, less than the first temperature. Typically, the third temperature is greater than the second temperature.

In one example, Step 804 deposits a first Si nanoparticle class having a largest diameter and a second Si nanoparticle class having a second-largest diameter equal to about (0.43)×(the largest diameter).

As a second example, Step 804 deposits Si nanoparticle classes having a first diameter ratio either about 77:32:17 or a second diameter ratio of about 77:32:17:D, where D is in a range of about 12-14. Alternately, the first ratio may be expressed as a weight % ratio of about 956:69:21.

As a third example, Step 804 may deposit Si nanoparticle classes and a Ge nanoparticle class in a size ratio of either about 7(Si):32(Ge), or about 77(Si):32(Si):17(Ge).

A Si nanoparticle precursor, precursor fabrication process, and precursor deposition process have been presented. Examples of particular size ratios and material combinations have been presented as examples. However, the invention is not necessarily limited to these examples. Other variations and embodiments of the invention will occur to those skilled in the art.

We claim:

1. A method for forming a silicon (Si) nanoparticle precursor, the method comprising:
providing a plurality of nanoparticle classes, including at least one Si nanoparticle class, the nanoparticles in each nanoparticle class having a predetermined diameter;
measuring a predetermined amount of each nanoparticle class; and,
combining the nanoparticle classes.

2. The method of claim 1 further comprising:
measuring a predetermined amount of liquid silane; and,
wherein combining the nanoparticle classes includes combining a plurality of Si nanoparticle classes with the liquid silane.

3. The method of claim 2 wherein measuring the predetermined amount of liquid silane includes measuring liquid silane with a volume in a range of about 5 to 15%, as compared to the combined volume of the Si nanoparticle classes.

4. The method of claim 1 wherein providing the nanoparticle classes includes providing at least one class of germanium (Ge) nanoparticles:
the method further comprising:
measuring a predetermined amount of liquid silane; and,
wherein combining the nanoparticle classes includes combining a Si nanoparticle class, liquid silane, and the Ge nanoparticle class.

5. The method of claim 1 wherein providing the Si nanoparticle class includes providing a first Si nanoparticle class having a largest diameter and a second Si nanoparticle class having a second-largest diameter equal to about (0.43)×(the largest diameter).

6. The method of claim 1 wherein providing the Si nanoparticle class includes providing Si nanoparticle classes having a diameter ratio selected from a group consisting of first ratio of about 77:32:17 and a second ratio of about 77:32:17:D, where D is in a range of about 12-14.

7. The method of claim 6 wherein measuring a predetermined amount of each Si nanoparticle class includes measuring the first ratio in a corresponding weight % ratio of about 956:69:21.

8. The method of claim 4 wherein providing the Si nanoparticle class and the Ge nanoparticle class includes providing diameter ratio selected from a group consisting of third ratio of about 77(Si):32(Ge) and a fourth ratio of about 77(Si):32(Si):17(Ge).

9. The method of claim 2 wherein measuring the predetermined amount of liquid silane includes measuring a liquid silane selected from a group consisting of monosilane, disilane, trisilane, cyclotrisilane, cyclobutasilane, cyclopentasilane, cyclohexasilane, and cycloheptasilane.

10. The method of claim 1 wherein providing the Si nanoparticle class includes supplying a Si nanoparticle class having a diameter tolerance in a range of ±10%.

11. The method of claim 1 further comprising:
measuring a predetermined volume of liquid germane in a range of about 0 to 1.5%, as compared to the combined volume of the Si nanoparticle classes; and,
wherein combining the nanoparticle classes includes combining a plurality of Si nanoparticle classes with the liquid germane.

12. A method for forming a silicon (Si) thin-film from a Si nanoparticle precursor, the method comprising:
providing a substrate;
depositing a Si nanoparticle precursor overlying the substrate, the Si nanoparticle precursor including a predetermined amount from at least one Si nanoparticle class, where each class includes nanoparticles having a predetermined diameter;
sintering the Si nanoparticle precursor at a first temperature, or less; and,
forming a Si thin-film.

13. The method of claim 12 wherein depositing the Si nanoparticle precursor includes depositing a Si nanoparticle precursor with a plurality of Si nanoparticle classes and a predetermined amount of liquid silane; and,
wherein sintering the Si nanoparticle precursor includes sintering at a second temperature, less than the first temperature.

14. The method of claim 13 wherein depositing the Si nanoparticle precursor with liquid silane includes depositing Si nanoparticle precursor with a volume of liquid silane in a range of about 5 to 15%, as compared to the combined volume of the Si nanoparticle classes.

15. The method of claim 12 wherein depositing the Si nanoparticle precursor includes depositing a Si nanoparticle precursor including a predetermined amount of at least one germanium (Ge) nanoparticle class and a predetermined amount of liquid silane; and,
wherein sintering the Si nanoparticle precursor includes sintering at a third temperature, less than the first temperature.

16. The method of claim 12 wherein depositing the Si nanoparticle precursor includes depositing a first Si nanoparticle class having a largest diameter and a second Si nanoparticle class having a second-largest diameter equal to about (0.43)×(the largest diameter).

17. The method of claim 12 wherein depositing the Si nanoparticle precursor includes wherein depositing Si nanoparticle classes having a diameter ratio selected from a group consisting of first ratio of about 77:32:17 and a second ratio of about 77:32:17:D, where D is in a range of about 12-14.

18. The method of claim 17 wherein depositing the Si nanoparticle precursor includes depositing the first ratio in a corresponding weight % ratio of about 956:69:21.

19. The method of claim 14 wherein depositing the Si nanoparticle precursor includes depositing Si nanoparticle classes and a Ge nanoparticle class selected from a group consisting of third ratio of about 77(Si):32(Ge) and a fourth ratio of about 77(Si):32(Si):17(Ge).

20. The method of claim 13 wherein depositing the Si nanoparticle precursor with liquid silane includes depositing a liquid silane selected from a group consisting of monosilane, disilane, trisilane, cyclotrisilane, cyclobutasilane, cyclopentasilane, cyclohexasilane, and cycloheptasilane.

21. The method of claim 12 wherein sintering includes an annealing operation, in an inert environment, selected from a group consisting of furnace, laser, rapid thermal, and flash lamp annealing.

22. The method of claim 12 wherein depositing the Si nanoparticle precursor includes depositing a Si nanoparticle precursor formed exclusively from Si nanoparticle classes; and,
wherein sintering the Si nanoparticle precursor includes sintering at the first temperature.

23. The method of claim 1 wherein providing the Si nanoparticle precursor includes supplying the nanoparticle classes dissolved in a solvent selected from a group consisting of hydrocarbon solvents, ether solvents, and polar solvents.

24. A silicon (Si) nanoparticle precursor comprising:
a combination of nanoparticle classes, including at least one Si nanoparticle class, the nanoparticles in each nanoparticle class having a predetermined diameter, and where the volume of each nanoparticle class is measured in a predetermined amount.

25. The precursor of claim 24 further comprising:
a predetermined amount of liquid silane; and,
wherein the combination of nanoparticle classes includes a plurality of Si nanoparticle classes.

26. The precursor of claim 24 further comprising:
a predetermined amount of liquid silane; and,
wherein the combination of nanoparticle classes includes at least one class of germanium (Ge) nanoparticles.
